(19) United States
(12) Patent Application Publication
(10) Pub. No.: US 2005/0289161 A1
(43) Pub. Date: Dec. 29, 2005

(54) Integrated document directory generator apparatus and methods

(75) Inventors: Brent L. Hadley, Kent, WA (US); Patrick J. Eames, Newcastle, WA (US); Susan C. Chew, Issaquah, WA (US)

Correspondence Address: BLACK LOWE & GRAHAM, PLLC, 701 FIFTH AVENUE, SUITE 4800, SEATTLE, WA, 98104, US

(73) Assignee: The Boeing Company, Chicago, IL (US)

(21) Appl. No.: 10/879,391

(22) Filed: Jun. 29, 2004

(51) Int. Cl. G06F 17/00

(52) U.S. Cl. 707/100

(57) ABSTRACT

The present invention is directed to systems and methods for the generation of integrated directories from database structures. In one embodiment, a system includes a database having a document tree that is generated from portions of other document trees, wherein the other document trees are related by at least one referential links, and a processor in communication with the database that is configured to extract a plurality of identifiers from the document tree and to generate an integrated directory from the document tree. In another aspect, a method includes selecting the document tree in a database, wherein the document tree is generated from portions of at least a first document tree and a second document tree, extracting identifying portions from the selected document tree, processing the identified portions to prepare user-accessible entries and positioning the entries in the directory.

### FIELD OF THE INVENTION

This invention relates generally to systems and methods for information management, and more particularly, to systems and methods for the generation of integrated directories from database structures.

### BACKGROUND OF THE INVENTION

In recent years, commercial enterprises have increasingly transferred documents of various types into information databases that may be directly accessed by a user. Information databases offer a level of convenience to a user because they do not require the user to access physical volumes containing indexed information, or to access drawing files, and the like. Similarly, the use of information databases is advantageous to commercial enterprises because it allows significant cost savings. For example, the information database generally supports “paperless” operation, thus generally eliminating paper and printing costs. The use of information databases also largely eliminates the substantial floor space requirements generally associated with document libraries, filing cabinets and drawing files, which are typically used to store paper documents. Most importantly, the use of information databases significantly reduces the amount of time a user must devote to acquiring needed documents.

The database architecture generally dictates how data is stored within the database and further, how data stored in the database is accessed. In many instances, the database has a hierarchical architecture, so that information in the database is accessed first through a main directory that provides a list of general topics that are similar in content and function to a table of contents in a book. Instead of page number references as in a table of contents, the main directory provides semantic associations that define paths between the general topics in the main directory and underlying sub-topical information in the database.

In order to assist a user of a database, referential links based on the semantic associations are often placed in various selected locations within a database, so that a user may quickly navigate from a source location to a destination location, as defined by the link. For example, the source location may be located in a first document in the database, and the destination location may be a second document in the database, or even in an entirely different database. Referential links thus provide a convenient method for rapidly moving from one portion of a database to another, or to move from one database to an entirely different one, so that a user avoids the need to “drill down” through the various levels in the database, or to exit the database and to access a new database in order to find related information of interest.

One example of an information database having a plurality of referential links is the Portable Maintenance Aid (PMA) that is offered by the Boeing Company of Chicago, Ill. The PMA includes aircraft maintenance information in a readily accessible format so that maintenance personnel may conveniently obtain desired maintenance information and view the information on a viewing device. FIG. 1 is a graphical view of a portion of the PMA 10 that includes a main directory 12 that lists the electronic documents that are available for a particular aircraft model, including an electronic version of an aircraft illustrated parts catalog (AIPC), an electronic version of an aircraft maintenance manual (AMM), as well as other documents that may be required to properly maintain the particular aircraft. Upon selecting a document 13 from the main directory 12, a user then selects a desired portion 14 of the selected document 13 from various sub-menus (not shown) or otherwise initiates movement within the selected document 13 until the desired portion 14 of the selected document 13 is viewed. Most of the documents in the PMA 10 include referential links so that a user may access portions of various documents directly. For example, illustrations 15 associated with the portion 14 may be accessed through referential links.

Although the PMA 10 affords significant advantages and constitutes an advance in the state of the art, a user is largely constrained to move within the PMA 10 according to predetermined routes that are established by the author. Although referential links may assist a user in accessing information within the database, the links are typically not formulated by the user and thus usually encode the human judgment of another. Accordingly, the links may not provide the flexibility that a user desires. Additionally, when referential links are relied upon for navigation to a desired document, the user must generally remember the one or more links that comprise the referential path, and successively activate the links in order to access the desired document.

What is needed in the art are apparatus and methods that permit a user to form a desired association between documents and generate an integrated directory that lists the documents, so that a user may directly and conveniently access the documents.

### SUMMARY OF THE INVENTION

The present invention is directed to systems and methods for the generation of integrated directories from database structures. In one aspect, a system for generating an integrated directory includes a database having a document tree that is generated from portions of other document trees, wherein the other document trees are related by at least one referential links, and a processor in communication with the database that is configured to extract a plurality of identifiers from the document tree and to generate an integrated directory from the document tree. In another aspect, a method for generating an integrated directory includes selecting the document tree in a database, wherein the document tree is generated from portions of at least a first document tree and a second document tree. The method further includes extracting identifying portions from the selected document tree, processing the identified portions to prepare user-accessible entries, and positioning the entries in the directory.

### BRIEF DESCRIPTION OF THE DRAWINGS

The preferred and alternative embodiments of the present invention are described in detail below with reference to the following drawings.

FIG. 1 is a graphical view of a portion of a hierarchical document database according to the prior art;

FIG. 2 is a block view of a system for generating an integrated directory from related document trees according to an embodiment of the invention;

FIG. 3 is a graphical representation of a plurality of hierarchical document trees that will be used to describe a method for generating an integrated document directory according to another embodiment of the invention;

FIG. 4 is a graphical view of an integrated directory according to an embodiment of the invention; and

FIG. 5 is a flowchart illustrating a method for generating an integrated document directory according to an embodiment of the invention.

### DETAILED DESCRIPTION OF THE INVENTION

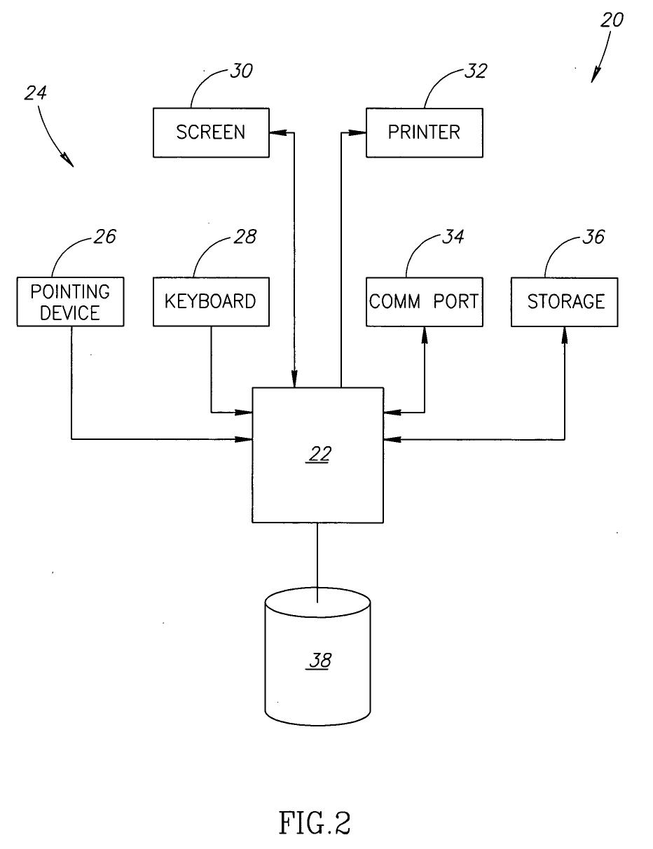

The present invention relates to systems and methods for generating a directory from related document trees. Many specific details of certain embodiments of the invention are set forth in the following description and in FIGS. 2 through 5 to provide a thorough understanding of such embodiments. One skilled in the art, however, will understand that the present invention may have additional embodiments, or that the present invention may be practiced without several of the details described in the following description.

FIG. 2 is a block view of a system 20 for generating an integrated directory from related document trees according to an embodiment of the invention. The system 20 includes a processor 22, which generally includes any programmable electronic device configured to receive programming instructions and input data, and to process the data according to the programming instructions. The processor 22 is coupled to a plurality of external devices 24, including a pointing device 26 operable to provide input commands to the processor 22, a keyboard 28 for the entry of text information and commands to the processor 22, a viewing screen 30 for viewing information generated by the processor 22. Other external devices 24 include a printer 32 operable to generate a printed copy of information generated by the processor 22, and a communications port 34 that may be coupled to other processors and/or input and output devices through a communications network. A storage device 36 configured to receive a removable data storage medium, such as a magnetic disk, an optical disk, a tape device or other similar storage devices is also coupled to the processor 22 so that information generated by the processor may be transferred to the removable storage medium.

The system 20 further includes a database 38 that includes at least one document tree generated from other previously existing document trees, as disclosed in detail in our co-pending U.S. patent application Ser. No. ______, entitled “APPARATUS AND METHODS FOR ACCESSING INFORMATION IN DATABASE TREES” filed May ______, 2004, under attorney docket number BOEI-1-1260, which application is incorporated by reference herein. Briefly, and in general terms, the at least one document tree in the database 38 may be generated from other document trees that are related by referential links that permit navigation between the documents present in each tree.

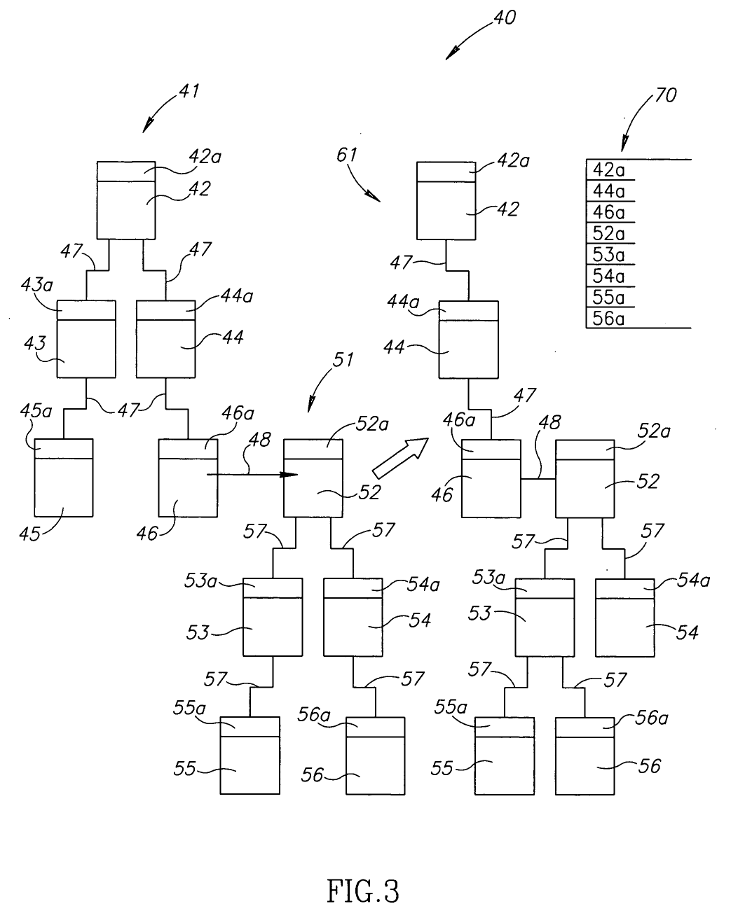

FIG. 3 is a graphical representation of a plurality of hierarchical document trees that will be used to describe a method 40 for generating an integrated document directory according to another embodiment of the invention. The method 40 includes a first document tree 41 having a root 42, branches 43 and 44 that depend from the root 42, and sub-branches 45 and 46 that depend from the branches 43 and 44. For clarity of illustration, only a portion of the branches and sub-branches of the first document tree 41 are shown. One skilled in the art will readily understand that other branches may be present, which may have still other sub-branches depending therefrom. The root 42, branches 43 and 44 and the sub-branches 45 and 46 are connected by pre-existing paths 47 that stem from the authorship of the document. The root 42, the branches 43 and 44, and the sub-branches 45 and 46 further include identifiers 42a, 43a and 44a, and 45a and 46a, respectively. The identifiers 42a, 43a and 44a, and 45a and 46a may be portions extracted from the respective root 42, branches 43 and 44, and sub-branches 45 and 46 that allow the root 42, branches 43 and 44, and sub-branches 45 and 46 to be categorized. For example, the identifiers 42a, 43a and 44a, and 45a and 46a may include title blocks, section identifiers or document numbers associated with the root 42, the branches 43 and 44, and the sub-branches 45 and 46, or any other predetermined portion of the root 42, the branches 43 and 44, and the sub-branches 45 and 46.

As further shown in FIG. 3, a second document tree 51 includes a root 52, branches 53 and 54 that depend from the root 52, and sub-branches 55 and 56 that depend from the branch 53. Again, for clarity of illustration, only a portion of the branches and sub-branches of the second document tree 51 are shown. One skilled in the art will again readily understand that other branches and sub-branches may be present. The root 52, branches 53 and 54 and the sub-branches 55 and 56 are connected by pre-existing paths 57 that stem from the authorship of the second document tree 51. The root 52, the branches 53 and 54, and the sub-branches 55 and 56 also include identifiers 52a, 53a, 54a, 55a and 46a, respectively.

The first document tree 41 and the second document tree 51 are linked by a referential link 48 that permits a user that accesses the first document tree 41 to move directly to the second document tree 51 by activating the link 48. For example, when the first document tree 41 and the second document tree 51 are comprised of hypertext documents, the link 48 is a hyperlink that may be activated by positioning the pointing device 26 of FIG. 2 on the link 48 and actuating the pointing device 26. Although only a single referential link 48 is shown in FIG. 3, it is understood that a plurality of referential links may be present in the first document tree 41 and the second document tree 51.

Still referring to FIG. 3, the referential link 48 forms a basis for combining the first document tree 41 and the second document tree 51, as further described in our co-pending U.S. patent application referenced above. Accordingly, the first document tree 41 and the second document tree 51 may be combined to form a third document tree 61. The third document tree 61 includes selected portions of the first document tree 41 and the second document tree 51 that are common to the link 48. The identifiers 42a, 44a and 46a are extracted from the third document tree 61 and processed to generate document links that are placed in an integrated document directory 70. Similarly, the identifiers 52a, 53a, 54a, 55a and 56a are extracted from the third document tree 61 processed to produce corresponding links and placed in the integrated document directory 70. The integrated document directory 70 thus provides a convenient and effective means for accessing documents within the third document tree 61, since the referential links are located in a common document.

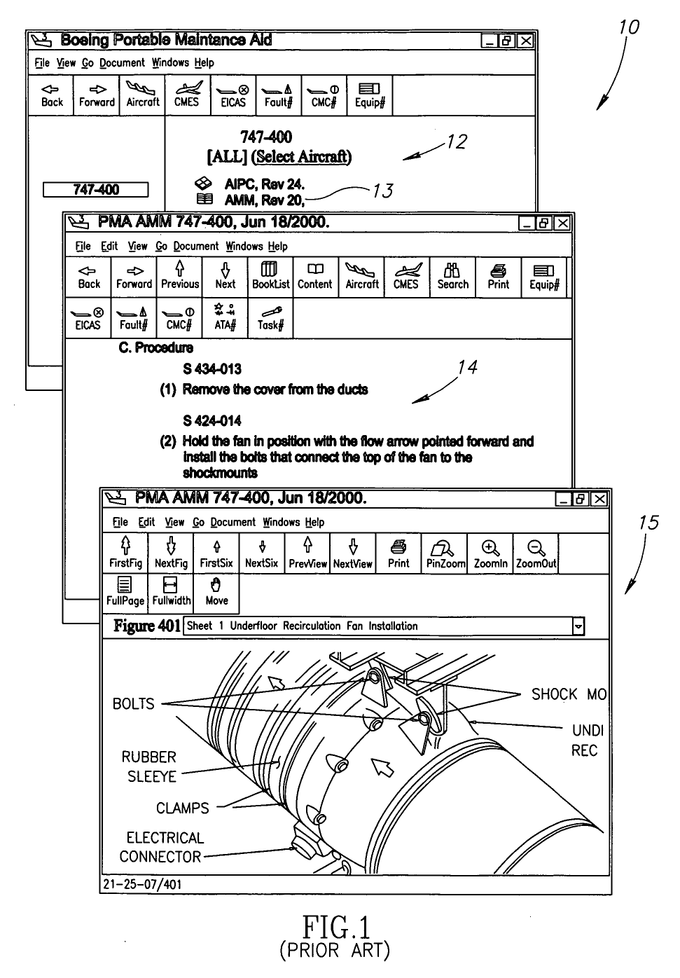

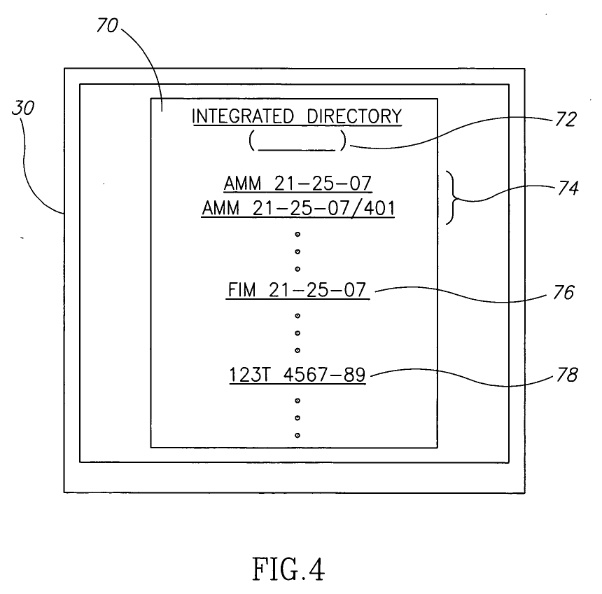

For example, and with reference now also to FIG. 4, the directory 70 is shown displayed on the display screen 30 of FIG. 2. The directory 70 includes a field 72 that identifies the directory 70 as stemming from the third document tree 61. The directory 70 also includes, for example, referential links to documents 74, which, in the present example, are portions of the AMM 13 of FIG. 1. The directory 70 may also include referential links to documents 76, which are portions of a Fault Isolation Manual (FIM) corresponding to the documents 74. Further, the directory 70 may also include referential links to documents 78, which are selected drawings from a drawing tree for the aircraft. Additionally, other documents may be included in the directory 70, which may include parts specifications, maintenance documents, inspection reports, and the like. Once generated, the document 70 may reside on the database 38 of FIG. 2. Accordingly, it is readily appreciated that the directory 70 may include links to document trees in different topic areas.

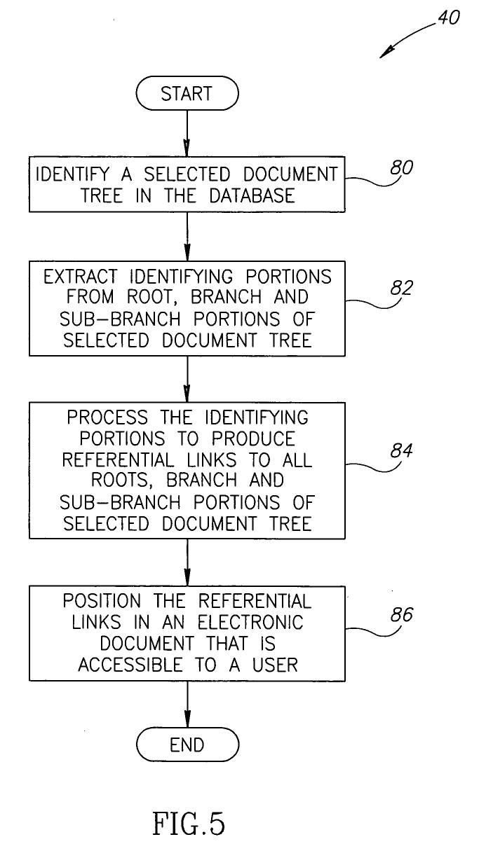

FIG. 5 is a flowchart further illustrating the method 40 for generating an integrated document directory. At block 80, the document tree for which an integrated directory is desired is identified. As noted earlier, the document tree is a previously generated document structure as disclosed in our co-pending application referenced above. At block 82, predetermined identifying portions present in each of the root, branch, sub-branch and any other portions of the document tree are extracted from the document tree and processed to generate referential links, as shown in block 84. At block 86, the referential links generated in block 84 are positioned in an integrated directory document, which may be stored in a database and accessed by a user.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A system for generating an integrated directory, comprising:
a database having at least one document tree generated from portions of at least a first document tree and a second document tree, the first document tree and the second document tree being related by at least one referential link; and
a processor in communication with the database and configured to extract a plurality of identifiers from the document tree and operable to generate an integrated directory from the document tree.

2. The system of claim 1, wherein the processor is further configured to process the plurality of identifiers extracted from the document tree and generate a plurality of referential links that are positioned in the integrated directory.

3. The system of claim 1, further comprising a plurality of external devices in communication with the processor.

4. The system of claim 3, wherein the plurality of external devices includes a keyboard and a pointing device operable to provide commands and data to the processor.

5. The system of claim 3, wherein the plurality of external devices includes a viewing screen operable to receive information generated by the processor and to display the information.

6. The system of claim 3, wherein the plurality of external devices includes a memory device operable to store information generated by the processor.

7. The system of claim 3, wherein the plurality of external devices includes a communications port operable to communicate information generated by the processor to a communications network.

8. A method of generating an integrated directory for an integrated document tree generated from a selected portion of a first document tree and a selected portion of a second document tree, the method comprising:
accessing a database that includes the integrated document tree;
locating a plurality of identifiers positioned within the integrated document tree;
processing the plurality of identifiers to form a plurality of corresponding referential links; and
compiling the referential links into the integrated directory to provide a user-manipulable functional link to selected portions of the integrated document tree.

9. The method of claim 8, wherein accessing a database that includes the integrated document tree comprises accessing the database through a communications network.

10. The method of claim 8, wherein locating a plurality of identifiers positioned within the integrated document tree comprises locating at least one of a title block, a section identifier or a document number in the integrated document tree.

11. The method of claim 8, wherein processing the plurality of identifiers to form a plurality of corresponding referential links comprises forming a plurality of hyperlinks.

12. The method of claim 8, wherein compiling the referential links into an integrated directory further comprises positioning a plurality of hyperlinks into the integrated directory.

13. The method of claim 8, wherein using the referential path to provide a user-manipulable functional link comprises placing the link in a user-retrievable document.

14. The method of claim 8, further comprising accessing the integrated document tree by manipulating a functional link in the integrated directory.

15. A method of generating an integrated directory for a document tree, comprising:
selecting the document tree in a database, wherein the document tree is generated from portions of at least a first document tree and a second document tree;
extracting identifying portions from the selected document tree;
processing the identified portions to prepare user-accessible entries; and
positioning the entries in the directory.

16. The method of claim 15, wherein selecting the document tree further comprises communicating a request for the document tree through a communications network.

17. The method of claim 15, wherein positioning the entries in the directory further comprises storing the directory in the database.

18. The method of claim 15, wherein processing the identified portions to prepare user-accessible entries further comprises generating referential links.

19. The method of claim 15, wherein processing the identified portions to prepare user-accessible entries further comprises generating a plurality of hyperlinks.

20. A displayable document generated from portions of a first document tree pertaining to a first subject matter and a second document tree pertaining to a second subject matter, comprising:
a first portion including entries extracted from the first document tree; and
a second portion including entries extracted from the second document tree.

21. The displayable document of claim 20, wherein the entries in the first portion and the entries in the second portion comprise referential links.

22. The displayable document of claim 21, wherein the referential links are generated from identifiers extracted from the first document tree and the second document tree.

23. The displayable document of claim 22, wherein the referential links are hyperlinks.

24. The displayable document of claim 20, wherein the document comprises one of a printed document, a hypertext document and a raster image on a viewing device.

25. The displayable document of claim 20, further comprising a document field indicating that the displayable document is generated from the first document tree and the second document tree.

26. A computer readable document generated from portions of a first source document pertaining to a first subject matter and a second source document pertaining to a second subject matter, comprising:
at least one first entry extracted from the first source document and at least one second entry extracted from the second source document.

27. The computer readable document of claim 26, wherein the at least one first entry and the at least one second entry further comprise referential links.

28. The computer readable document of claim 27, wherein the referential links comprise hyperlinks.

29. The computer readable document of claim.26, wherein the first source document comprises a first document tree, and the second source document comprises a second document tree.

30. The computer readable document of claim 26, wherein the document is configured to be stored on at least one of a magnetic disk device, an optical disk device, a tape device and a computer network.

31. A method of navigating between a portion of a first document tree and a portion of a second document tree, comprising:
selecting identifiers from the portion of the first document tree and the portion of the second document tree;
combining the identifiers in a directory;
accessing the directory to identify a selected one of the identifiers; and
moving to a desired location in one of the first document tree and the second document tree.

32. The method of claim 31, wherein selecting identifiers comprises locating at least one of a title block, a section identifier or a document number in the respective portions.

33. The method of claim 31, wherein selecting identifiers comprises selecting referential links from the respective portions.

34. The method of claim 33, wherein selecting referential links from the respective portions further comprises selecting hyperlinks.

35. The method of claim 31, wherein combining the identifiers in a directory further comprises storing the directory in a database.

36. The method of claim 31, wherein moving to a desired location in one of the first document tree and the second document tree further comprises activating a referential link with a pointing device.

37. A method of generating an integrated directory from a pre-existing first document tree and a pre-existing second document tree, comprising:
locating at least one identifier in the first document and at least one identifier in the second document;
extracting the at least one identifier in the first document and at least one identifier in the second document; and
combining the extracted identifiers in the directory.

38. The method of claim 37, wherein locating at least one identifier in the first document and at least one identifier in the second document further comprises identifying at least one of a title block, a section identifier or a document number in the first document and the second document.

39. The method of claim 37, wherein locating at least one identifier in the first document and at least one identifier in the second document further comprises locating referential links in the first document and the second document.

40. The method of claim 39, wherein locating referential links in the first document and the second document comprises selecting hyperlinks.

41. The method of claim 37, further comprising storing the directory in a database.
